(19) United States
(12) Patent Application Publication
(10) Pub. No.: US 2020/0055510 A1
(43) Pub. Date: Feb. 20, 2020

(54) Real-time self-Diagnose Device for air brake system

(71) Applicant: Mudalige Sanath Gnanadarsha Gunawardana, Rockford, IL (US)

(72) Inventor: Mudalige Sanath Gnanadarsha Gunawardana, Rockford, IL (US)

(21) Appl. No.: 16/104,909

(22) Filed: Aug. 19, 2018

(51) Int. Cl. B60T 17/22

(52) U.S. Cl. CPC B60T 17/221; B60T 2270/10

(57) ABSTRACT

Real-time self-diagnose device for brake system comprise of, system to avoid zero braking effort, brake parts monitoring system, and anti-false alarm system. Whenever driver applies service brakes Real-time self-diagnose device for brake system will real time monitor the condition of brake components and report findings to driver, by a visual display with an audio signal. Same time it will give a digital signal to ABS prompting to disregard this low or no braking effort of the wheels with defective brake parts & provide normal braking to all other wheels, to avoid zero braking effort scenario.

### CROSS REFERENCE TO RELATED APPLICATIONS

None

### BACKGROUND OF THE INVENTION

There are many pneumatic valves, air lines, mechanical linkages and pneumatic actuators between the service brake pedal in the driver cab where the braking process is initiated and the brake drum where the braking effort is implemented. The fail-safe pneumatic brake system, equipped with the ABS feature, is used in semi-trucks today. Still however, any of the above-mentioned components do fail (possibly due to wrong installation, material fatigue, end of life cycle, vandalism or other reasons) to perform the task whilst the vehicle is in operation, resulting with the vehicle brake system producing zero braking effort.

The ABS (Anti-lock Brake System) is incorporated to detect and prevent excessive braking effort on an individual wheel, to prevent the wheels from locking. The ABS are not designed to rectify zero braking effort of an individual wheel. The ABS does detect a component failure, and if such a failure exists, ABS will switch to default mode disabling ABS brake regulators to avoid zero braking effort. It takes approximately of seven seconds or couple of braking cycles or sensing cycles to do so. As we know that many seconds with zero braking effort, creates a large window for unsafe accidents to occur.

### FIELD OF THE INVENTION

Patent primary class to be determined by USPTO.

### SUMMARY OF THE INVENTION

Real time self-diagnose device for brake systems is named as NP Device series version 1 & version 2, hereafter throughout this document will be referred to as NP Device.

Whenever driver applies service brakes NP Device will real time monitor the condition of brake components and report findings to driver, by a visual display with an audio signal. Same time it will give a digital signal to ABS prompting to disregard this low or no braking effort of the wheels with defective brake parts & provide normal braking to all other wheels, to avoid zero braking effort scenario.

In a such event, brake system, is not operating with its full capacity. Nonetheless this arrangement will enable the driver to avoid/minimize damage due to rear end collision or steer clear the truck while controlling the speed to avoid rollover. All this process will take 1 to 2 seconds compared to more time taken by ABS to detect the defect.

Defective brake could cause vehicle to pull to a side. NP Device will advise driver which way to counter steer to control direction, while applying brakes. In the event of one steer tire wheel losing brake, NP Device flags ABS to limit 50% of the air supply to brake chamber of the opposite side steer tire wheel, to avoid vehicle dragging to side. NP Device is capable of detecting whether defect is in the pneumatic components or with the mechanical components of the brake system. During pre-trip driver can check brake equipment of all the wheels without going under the vehicle. NP Device can detect when brake shoe is close to DOT accepted limit. While driving the vehicle, if defect occurs in the brake system, driver will be notified sooner driver press the brake pedal & vehicle will not lose braking effort completely.

There is a self-diagnose system, incorporated with the NP Device series v1 & v2 to warn driver in the event of NP Device series v1 & v2 has a component failure. It will pinpoint which component of the NP Device is defective. There by it will not cause false alarm scenario.

### BRIEF DESCRIPTION OF DRAWINGS

All drawings, and figures are not to scale. Parts and vital points are shown with numbers. FIGS. 1 to 15 is spread out in 6 sheets.

FIG. 1 depicts top view of the displacement senor of brake shoes. (sheet 1).

FIG. 2 illustrates cross-sectional view of FIG. 1. (sheet 1).

FIG. 2A illustrates sensor on brake chamber & sensor on air line to brake chamber. (sheet 1).

FIG. 3 illustrates the construction of displacement transfer cable. (sheet 1).

FIG. 4 depicts top view of the movement regulator. (sheet 2).

FIG. 5 illustrates the cross-sectional view of FIG. 4. (sheet 2).

FIG. 6 depicts the top view of the rotating platform. (sheet 2).

FIG. 7 depicts the bottom view of the rotating platform. (sheet 2).

FIG. 8 depicts the top view of the switching arm. (sheet 3).

FIG. 9 depicts the top view of the pulley & return spring holder. (sheet 3).

FIG. 10 illustrates the cross-sectional view of the FIG. 9. (sheet 3).

FIG. 11 depicts the top view of the main base. (sheet 4).

FIG. 12 illustrates the cross-sectional view of the FIG. 11. (sheet 4).

FIG. 13 depicts front view of the display console on driver cab dashboard. (sheet 4).

FIG. 14 illustrates the cross-sectional view of the assembled combination box. (sheet 5).

FIG. 15 demonstrate the general outline of the NP Device system. (sheet 6).

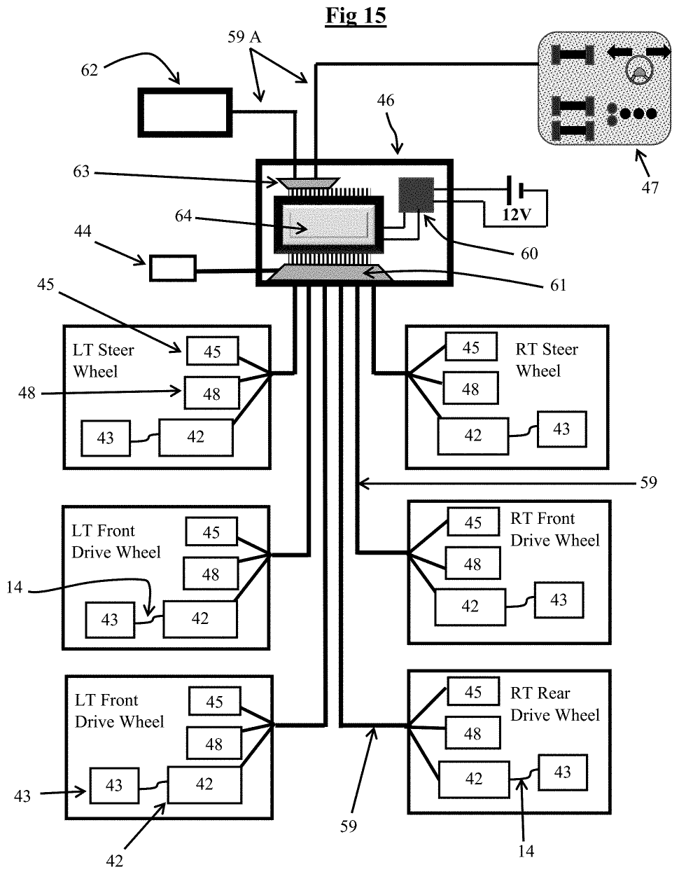

### DETAIL DESCRIPTION OF NP DEVICE v1 (FIG. 15)

NP Device comprise of, system to avoid zero braking effort, brake parts monitoring system, and anti-false alarm system. The components of the NP Device fall into two categories such as components shared by all systems, and components related only to a specific system.

The NP Device v1 comprise of brake shoe displacement sensors 43 with displacement transfer cables 14; combination boxes 42, with displacement multiplier 25, 33 and wear & tear compensator 17, 22, 24; air chamber sensors 48, air line sensors 45, brake pedal sensor 44, wire harness 59, 59A, logic comparator 46 and display console 47.

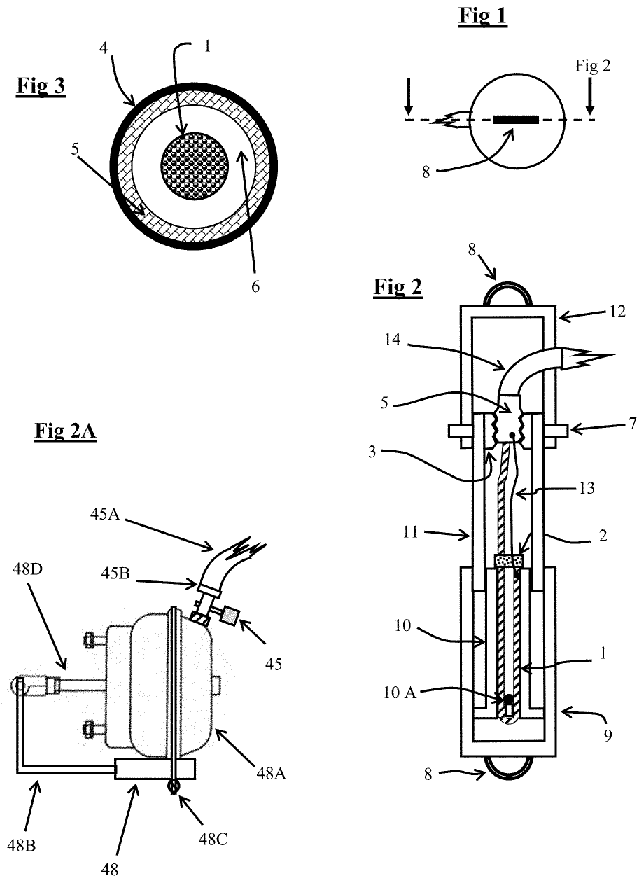

### Brake Shoe Sensor 43 (FIG. 1, 2,3)

A displacement sensor is installed between brake shoes and attached to displacement transfer cable. Primary function of the brake shoe sensor 43 is to measure total displacement of the brake shoes. Brake shoe sensor 43 consist of 4 parts. All parts are assembled, to perform telescopic movements. Brake shoe sensor is, made of metal, then covered with anti-corrosive and heat resistance coating. Brake shoe sensor 43 parts are as follows.

Cable locker 10 is a T shape cylindrical part, with two pass through holes from top to bottom, to accommodate inner cable 1. Inner cable 1 is attached to cable locker 10 using inner cable locking device 2. Cable locker 10 is secured to bottom cover 9 with a metal pin 10A inserted through bottom cover 9 & cable locker 10.

The bottom cover 9 attaching handle 8 is connected to bottom brake shoe using an adjustable link made from 1/16″ steel cable coated with 1/32″ thick coating of high temperature resistance dielectric material.

Cable outer locker 11. The cable outer 5 is locked with cable outer locker 11 using, screw type housing 3. Then cable outer locker 11 is secured to the sensor top cover 12 with metal pins named locking posts 7 using cold welding.

Sensor top cover 12 attaching handle 8 is attached to the top brake shoe using a link made from 1/16″ steel cable coated with 1/32″ thick coating of high temperature resistance dielectric material. Displacement transfer cable 14 is inserted into sensor through a hole on the side of the top cover 12.

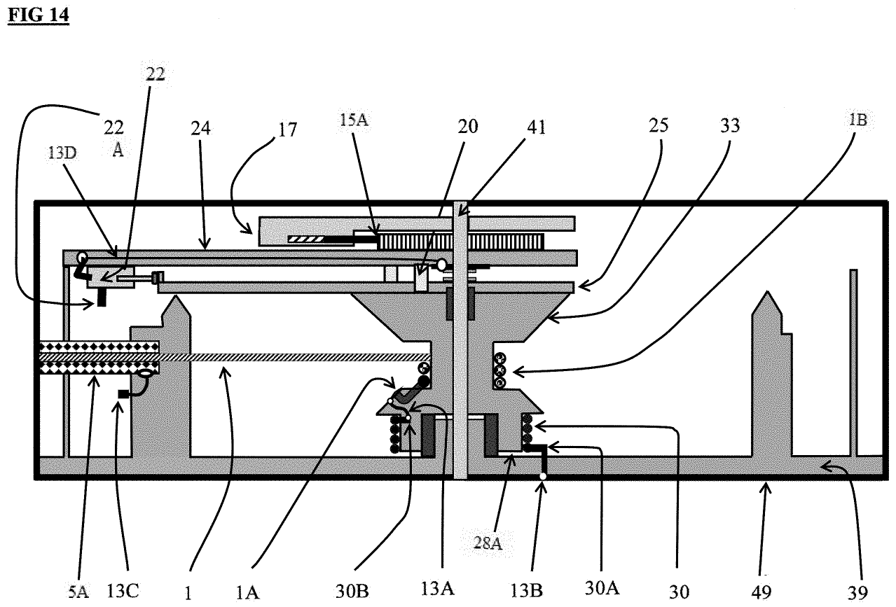

When driver press the brake, both shoes travel resulting sensor top cover 12 with cable outer locker 11 & bottom cover 9 with cable locker 10, to move with the brake shoes. This will move inner cable 1 towards bottom shoe and cable outer 5 towards the top shoe. This displacement is transferred to combination box 42, via a displacement transfer cable 14. This displacement will result inner cable 1 (FIG. 14) to pull into cable outer 5A (FIG. 14), at combination box 42 end.

### Displacement Transfer Cable 14 (FIG. 3)

It is a basic displacement transfer cable with an inner cable and cable outer. Added casing is introduced between cable outer and inner cable. Cable outer consist of two layers and they are named as first casing 4, second casing 5 and second casing is referred as cable outer 5 throughout of this document. Primary function is to transfer displacement. Secondary function is to conduct electricity. Details of the parts are as follows.

First casing 4 is made of heat & corrosive resistance nonmetal material to protect the parts of the cable from heat, dust, and moisture.

Second casing 5, made of flexible tubing material, capable of conducting electricity and function as cable outer. Throughout this document second casing 5 will be referred to as cable outer 5.

Third casing 6, made of electrical insulation and dielectric material, placed between cable outer 5 & inner cable 1, to form an electrical insulation barrier.

Inner cable 1, made of materials capable of conducting electricity and same time transfer the displacement to pulley 33 (FIG. 14) in combination box 42.

### Combination Box 42 (FIG. 14, 15)

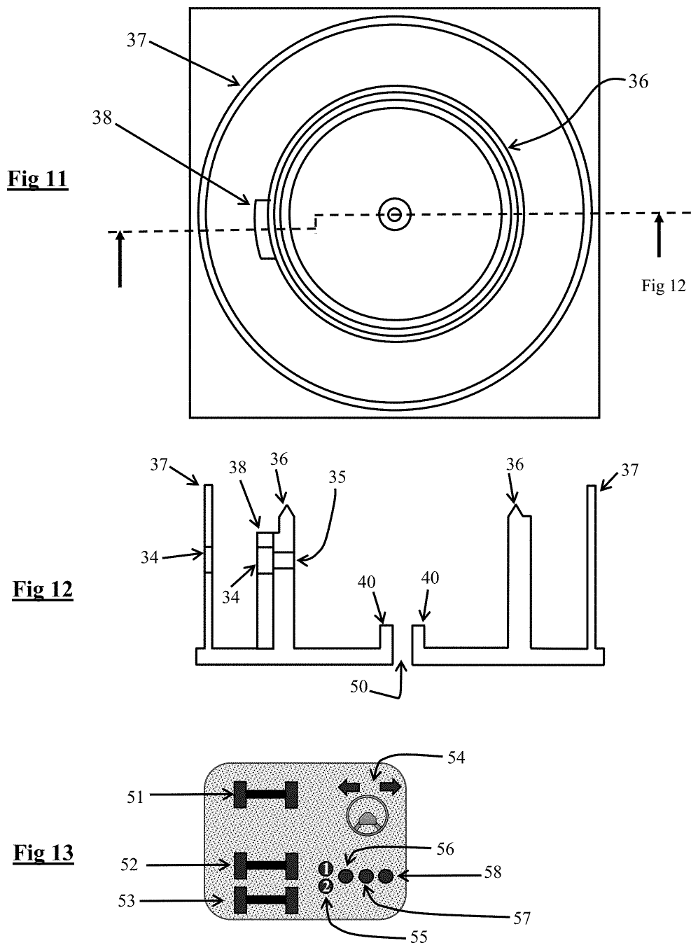

There are two combination boxes 42 per axle to monitor brake shoe displacement of left & right wheel. Each combination box 42 consist of following components mounted on a ⅛″ vertical axle 41 which is secured to outer cover 49 from top & bottom. All components has a hole 50 (FIGS. 1 to 12) to accommodate vertical axle 41. Outer cover 49 is made of 1/16″ metal sheeting with heart insulation & water proof coating. Displacement multiplier, wear & tear compensator has components as described below, and all these components are placed inside a combination box.

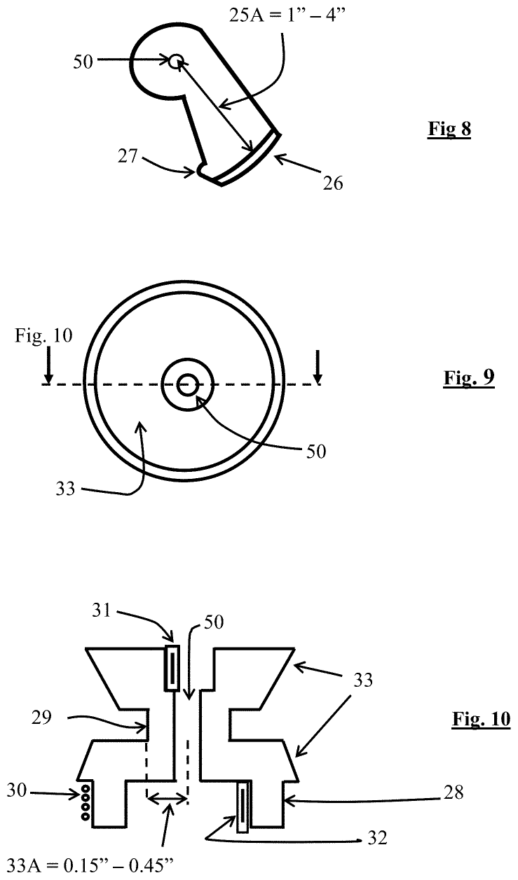

### Displacement Multiplier 25, 33 (FIG. 8, 9, 10)

A displacement transfer cable is attached to a pulley with an arm to convert slightest linear displacement in to a larger angular movement. The secondary task of the displacement multiplier is to operate an electrical switch using angular movement.

Displacement multiplier 25, 28, 33, 30 31, 32 comprises of following, working as a one piece. Switching arm (FIG. 8), 25 (FIG. 14), pulley 33, return spring holder 28, return spring 30, self-lubricating top needle bearing 31 and self-lubricating bottom needle bearing 32.

Pulley 33 top is secured to switching arm 25 (FIG. 14) forming a one piece. This complete piece is mounted on a vertical axial 41 using two self-lubricated needle bearings 31, 32. The length 25A from switching arm lip 26 to the center of the hole 50 for vertical axle 41, is much greater than the length 33A from pulley groove bottom 29, to the center of the hole 50 for vertical axle 41. The switching arm length 25A varies from 1″ to 4″ depending on the vehicle it is installed. Similarly, radius of the pulley at pulley groove bottom 33A varies from 0.150″ to 0.450″, depending on the vehicle it is installed.

The inner cable 1 is coiled around 1B (FIG. 14) the pulley groove 29 and secured to pulley 1A (FIG. 14). Return spring 30 is coiled around return spring holder 28. One end of the return spring 30B (FIG. 14) is secured to return spring holder 28, while other end 30A (FIG. 14) is secured to main base platform 39.

When brakes are applied, inner cable 1 (FIG. 14) is pulled towards the brake sensor. Inside the combination box 42 inner cable 1 will move away from pulley and retract into the cable outer 5A (FIG. 14). This will result inner cable 1 (FIG. 14) to unwind from pulley groove 1B (FIG. 14), forcing pulley 33 to rotate clockwise. The switching arm 25 (FIG. 14) will rotate with pulley 33 and shift the switch 22 (FIG. 14) to OFF position. When brakes, are released inner cable 1 (FIG. 2) will retract from brake shoe sensor 43 into combination box 42, resulting inner cable 1 (FIG. 14) to move towards the pulley 33 (FIG. 14). Subsequently pulley 33 will rotate anti clockwise due to return spring 30 tension, resulting inner cable 1 to coiled around the pulley groove 1B (FIG. 14). Switching arm 25 will return to its original position, releasing the switch 22 to ON position.

Purpose of switching arm 25 initiating tip 27, is to apply pressure on activating point roller 23 (FIG. 7), to move down until activating roller 23 reaches switching arm lip 26. The switching arm lip 26 will keep the activating point roller 23 pressed down until switching arm 25 rotates back to default position.

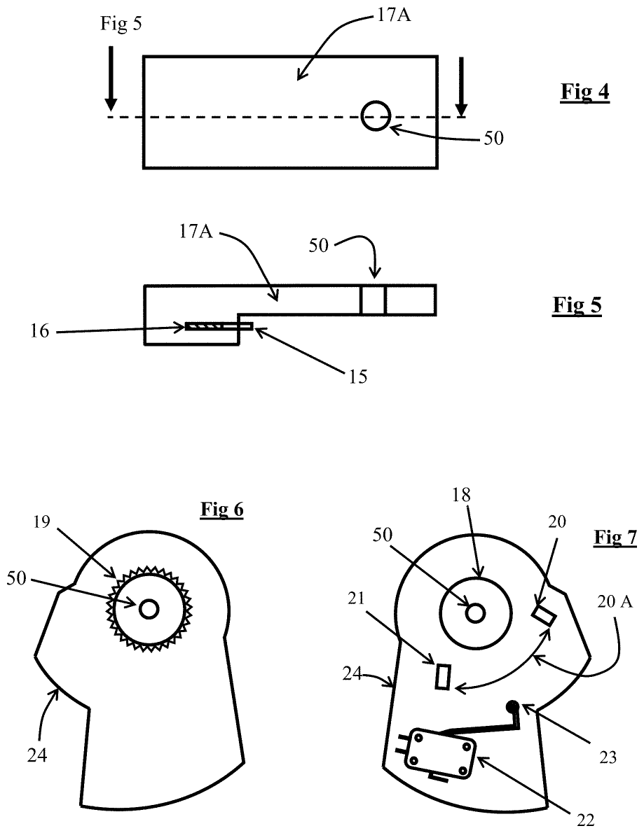

### Wear & Tear Compensator 15, 17 (FIG. 4, 5, 6, 7, 14)

Wear & tear compensator comprises of following, working as a one group. Movement regulator 17 with locking pin 15, recoil spring 16; and rotating platform 24 with, gearwheel 19, progressive direction stopper 20, retrieve direction stopper 21, switch 22, metal washer 18 to hold rotating platform on axle 41.

As brake shoes get warn out, brake shoe displacement increases. When brakes are released, distance it returns stay the same due to auto slack adjuster in brake system. This will cause the switching arm 25 to shift its normal operating range 20A, resulting switch activating point roller 23, not aligning with switching arm lip 26 operating range 20A. To overcome this limitation, switch 22 is mounted on a rotatable platform called rotating platform 24. Rotating platform is mounted on top of switching arm 25, enabling switch 22 to move and stay within operating range 20A of switching arm 25.

Progressive direction stopper 20 and retrieve direction stopper 21, placed & secured on each side of the rotating platform 24 in a such a, way when switching arm 25 attempt to exceeds its normal operating range 20A on either direction, switching arm 25 can exert force on either one of the stoppers 20, 21 to move the rotating platform 24 with the switch 22. The range between two stoppers where switching arm travels, is named as normal operating range 20A of switching arm.

A gear wheel 19 is secured to rotating platform 24, forming one piece. Movement regulator 17 is placed on top of rotating platform 24 in a such a way gear wheel 19 tooth will engage with locking pin 15A (FIG. 14). Movement regulator 17 is a locking device placed to prevent rotating platform 24 movement, until switching arm 25 apply force on rotating platform stoppers 20, 21.

When switching arm travel to activate switch 22, rotating platform 24 stays in a firm position due to teeth of gear wheel 19, is held by locking pin 15A. Sooner switching arm attempt to travel beyond progressive direction stopper 20, switching arm 25 will apply force on stopper 20. This force is transferred to rotating platform 24, then to teeth of the gear wheel 19, and finally ends at tip of the locking pin 15A. This will overcome the tension of pin recoil spring 16 in movement regulator 17. Above process and wide-angle shape of the locking pin tip 15A, will force the locking pin 15 to retract from gear tooth by sliding on the gear tooth side wall, allowing rotating platform 24 to rotate with the switching arm 25.

Once brakes are released switching arm 25 will move away from progressive direction stopper 20 and stop before it reach the retrieve direction stopper 21. Sooner the switching arm 25 remove pressure on progressive direction stopper 20 the pin recoil spring 16 tension will push the locking pin 15 out, to engage with teeth of gear wheel 19 to hold rotating platform 24 in a firm position. Same process will occur when switching arm 25 interact with retrieve direction stopper 21. This arrangement compensates extra displacement due to wear & tear of the brake shoe.

When new brake shoes are installed there will be no additional displacement due to wear & tear. Hence the inner cable 1 is released from brake shoe sensor (FIG. 2). This will allow pulley 33 and switching arm 25 to rotate due to pulley return spring 30 (FIG. 14) tension. Switching arm 25 will push retrieve stopper 21, which will unlock locking pin 15, and take the rotating platform 24 to its factory original position. Hence it has automatic rest capability.

### Air Line Sensor 45 (FIG. 2A)

Air line sensor 45 is installed at the union 45B, which connects air supply line 45A to air chamber 48A. This sensor 45 will measure the air pressure at the union 45B. When air pressure is below the operating pressure of the air chamber 48A, the sensor 45 will emit continuous signal to logic comparator 46 via wire harness 59. When brakes are applied, air pressure will reach the operating threshold of the air chamber 48A, resulting air line sensor 45, to cut off, the continuous signal to logic comparator 46.

### Air Chamber Sensor 48 (FIG. 2A)

Air chamber sensor 48 is secured to air chamber 48A using bracket 48C. Sensor arm 48B is linked with push rod 48D to measure the displacement of the pushrod 48D. When air chamber 48A is not pressurized, pushrod 48D stays all the way into the chamber 48A, and sensor 48 will emit a continuous signal to logic comparator 46, via wire harness 59.

When brakes are applied air is pressurized into the brake chamber 48A, resulting pushrod 48D to span out and push slack adjuster arm. The sensor 48 will measure this displacement using sensor arm 48B movement, and sensor 48 will cut of, the continuous signal to logic comparator.

### Switch 22 (FIG. 7)

A switch 22 integrated with wear & tear compensator to convert displacement into an analogue signal. When brakes are released switch 22 stay in default setting, which is ON position and feed a continuous signal to logic comparator 46. When brakes are applied switch 22 will move to OFF position and disconnect the continuous signal. Switch output will not emit continuous signal as far as switching arm hold switch in off position.

### Main Base (FIG. 11, 12, 14)

Main base comprises of hole to accommodate cable outer 34, hole to accommodate inner cable 35 in cable guide stand 38. Switching arm 25 rides on tip of post support switching arm 36 and rotating platform 24 rides on tip of post support rotating platform 37. Both are circular ridge shape parts, to give stability against road vibration. Cable outer 5 of displacement transfer cable 14 is secured to, hole 34 in cable guide stand 38. Inner cable 1 is inserted through the hole 35 in cable guide stand 38 to align inner cable 1 with pulley groove 1B (FIG. 14).

Bearing housing post 40 which is a circular ridge, which hold the bottom needle bearing 32. Height of the, post 40 and return spring holder 28 is made ⅛″ shorter than the height of bottom needle bearing 32. This is to create a gap between main base platform 39 and return spring holder bottom 28A (FIG. 14) as well as a gap between the top of the post 40 and bottom of pulley 33; to avoid dragging. Main base platform 39, and all above parts are molded as a one piece.

### The Sequence of Assembling (FIG. 2, 14)

Manufacturing process of the NP Device is very critical to the accurate operation of the displacement multiplier 25, 33 & wear and tear compensator 17, 24. Process should start with attaching displacement transfer cable 1, 5 to brake shoe sensor 43. Thereafter complete, the assembling of brake shoe sensor 43 and then connect the cable outer 5 to cable guide stand 38. Finally end sequence by securing 1A inner cable 1 to pulley 33 in displacement multiplier.

### Wire Harness 59, 59A (FIG. 15)

Wire harnesses 59, are used to connect air chamber sensors 48, air line sensors 45, combination boxers 42, brake pedal sensor 44 to a logic comparator 46. This is to provide power from logic comparator 46, to powerup the combination boxes 42 air line sensors 48, air chamber sensors 45. Same time it will carry the output signals from combination boxes 42, air line sensors 48, air chamber sensors 45, brake pedal sensor 44 to logic comparator 46. Second wire harness 59A connects logic comparator 46, to display console 47; and anti-lock brake system via vehicle brake control module 62. Wire harnesses are installed inside a casing, to withstand 300 F.

### Logic Comparator (FIG. 15)

Logic comparator 46 consist of a module with digital gates 64, input panel 61, output panel 63 and a 12 V regulated DC power supply 60. Input panel 61 will receive signals from combination boxers 42, air chamber sensors 48, air lines sensors 45, brake pedal sensor 44; via wire harnesses 59. Logic comparator will analyze all signals and release output signals to display console 47 and ABS in vehicle brake control module 62. All output signals released by logic comparator, is routed via its output terminals connected to second wire harness 59A; except for the 12V negative signals to combination boxes and other sensors.

The vehicle battery provides 12 V power to power supply. Primary task of the power supply is to maintain 12 V by regulating the input, using filters with full wave rectifier to eliminate noise and spikes. This is the primary power source for power consuming components in NP Device.

### Brake Parts Monitoring System (FIG. 2A, 14, 15)

This system monitor components of the vehicle brake system. Brake parts monitoring system use brake shoe sensors 43 with displacement transfer cable 14; all components in combination boxes 42, except for conductors 13A, 13B, 13D and cable outer terminals 13C; air chamber sensors 48, air lines sensors 45, brake pedal sensor 44, logic comparator 46, wire harness 59, 59A, display console 47.

If switch output 22A in combination boxes 42, air chamber sensors 48, air line sensors 45, stop feeding continuous signals, to logic comparator; soon after brake pedal sensor 44 signal to logic comparator becomes greater than zero; display console 47 will receive a signal from logic comparator to indicate all systems are good.

If any one or more combination boxers switch 22 and brake pedal sensor 44, simultaneously feed continuous signals to logic comparator; brake parts monitoring system will flag logic comparator. In turn logic comparator will signal, display console to indicate mechanical components, of respective wheel is defective.

If any one or more or combination of air line sensors 45, air chamber sensors 48, feed continuous signals to logic comparator; even after brake pedal sensor 44 signal to logic comparator becomes greater than zero, brake parts monitoring system will flag logic comparator; to signal display console to indicate, one or more pneumatic components of respective wheel is defective.

### System to Avoid Zero Braking Effort (FIG. 2A, 14, 15)

System to avoid zero braking effort, use brake shoe sensors 43, combination boxes 42, air chamber sensors 48, air lines sensors 45, brake pedal sensor 44, logic comparator 46, wire harness 59, 59A, brake control module of the vehicle 62.

Sooner brake parts monitoring system detect a defective component in vehicle brake system; the system to avoid zero braking effort will flag logic comparator 46 to feed a signal, to vehicle brake control module 62, to prompt Anti-lock Brake System to disregard the wheels associated with the defective components and provide normal braking to all other wheels, to avoiding zero braking effort scenario.

### Anti-False Alarm System (FIG. 2, 14, 15)

Anti-false alarm system will perform the task of real time self-diagnose process to detect defective components of the NP Device v1, to avoid Real-time Self Diagnose device for brake system producing a false alarm condition. Anti-false alarm system maintains closed loop circuits using components of the NP Device to monitor their condition.

This system use inner cable 1, cable outer 5, conductor 13 in brake shoe sensors 43; pulley return spring 30, conductors 13A, 13B, 13D, outer cover 49, cable outer terminal 13C on cable guide stand 38, switch 22, in combination boxes; air line sensors 45, air chamber sensors 48, brake pedal sensor 44, logic comparator 46, wire harnesses 59, 59A , circuit connected to amber light 57 and circuit connected to wheel indicators 51, 52, 53, in display console 47.

Power supply 60 in logic comparator 46, is electrically bridged with outer cover 49 of combination box 42, using a wire harness 59; while outer cover 49 is bridged 13B with one end 30A, of the pulley return spring 30 and other end of the spring 30B is bridged with inner cable 1 using a conductor 13A at return spring holder; wherein inner cable 1 is bridged with cable outer 5 using a conductor 13 inside brake shoe sensor 43 and cable outer 5 is connected to terminal 13C on cable guide stand 38; and terminal on cable guide stand, is linked back to logic comparator using a wire harness. This complete the first closed loop circuit. Parallelly outer cover 49 is connect to input terminal of the switch 22 via a conductor 13D, metal washer and vertical axle 41.

Continuous 12V negative signal from logic comparator 46, is supplied to outer cover 49 of combination boxes 42, input terminals of air line sensors 45, input terminals of air chamber sensors 48 using wire harnesses 59. Terminals 13C on cable guide stands, switches output 22A, air line sensors output 45, air chamber sensors output 48 are parallelly connected to logic comparator 46 input panel 61 (FIG. 15) via wire-harnesses 59 (FIG. 15) as separate inputs. This complete rest of the closed loop circuits.

When brake pedal sensor 44 not emitting a signal, switches output 22A, air line sensors 45, air chamber sensors 48 will emit continuous 12V negative signals. Whereas, terminal 13C on cable guide stands in combination boxes, will emit 12V negative continuous signal, irrelevant to what vehicle brake system statuses is. If these continuous negative signals are lost anti-false alarm system will recognize NP Device is defective.

Sooner anti-false alarm system recognize NP Device is defective the logic comparator 46 will be flagged by the anti-false alarm system to disable all terminals of output panel 63, except connection to display console 47. This will avoid false alarm situation with ABS. Simultaneously anti-false alarm system will flag logic comparator 46 to instruct display console 47 to glow amber LED 57, along with respective wheel indicator 51, 52, 53. The anti-false alarm system will keep flagging logic comparator 46 until defect is rectified and all continuous signals are present at logic comparator 46.

Display console 47 (FIG. 13. 15)B. This consist of 3 display areas as follows. Wheel indicators 51, 52, 53. Each wheel is represented by a rectangular integrated with green & red LED. Based upon the signal fed by the logic comparator 46 one of the LED will glow to indicate the condition of the brake parts & NP Device parts, related to wheel. Green indicates condition good & red indicate condition is defective.

General indicators 55, 56, 57, 58. Red 1 LED 55 indicates air chamber defective. Red 2 LED 55 indicates air supply line to air chamber is defective. Blue 56 indicates brake shoes are worn out. Amber 57 indicates NP Device is defective. Green 58 indicates all systems good. When red 1, red 2, blue, amber glow to indicate a defect, simultaneously one of the red LED on the wheel indicators will glow to indicate which wheel is associated with the defective part.

Counter steer indicator 54 (FIG. 13), will advise driver which way driver should be prepared to counter steer in the event of vehicle dragging to one side when applied defective brakes. This may help driver to keep the vehicle direction steady when apply brakes.

### Details of Np Device v2

This system is same as NP Device v1 except this version utilize a magnetic sensing device to sense the displacement of the brake shoes. Hence it eliminated the combination boxes 42 & directly feed the sensor output to logic comparator.

The invention claimed is:

1. Claim; Real-time Self Diagnostic device for brake system, comprise of, system to avoid zero braking effort, anti-false alarm system, brake parts monitoring system.

2. Claim; Real-time self-diagnostic device for brake system, comprises of at least one or more following components and its details are; displacement sensor, installed between brake shoes, is attached to a displacement transfer cable, which is attached to a pulley with an arm, to operate an electrical switch, integrated with wear & tear compensator to convert displacement into an analogue signal; wherein all these components are placed inside a combination box; and a wire harnesses are used, to connect air chamber sensors, air line sensors, combination boxers, brake pedal sensor to a logic comparator; and second wire harness connects logic comparator, to display console; and anti-lock brake system via vehicle brake control module.

3. Claim of claim 1; system to avoid zero braking effort is design in such a way, sooner brake parts monitoring system detect a defective component in vehicle brake system; the system to avoid zero braking effort will flag logic comparator to feed a signal, to vehicle brake control module, to prompt Anti-lock Brake System, to disregard the wheels associated with the defective components and provide normal braking to all other wheels.

4. Claim of claim 1; anti-false alarm system will perform the task of real time self-diagnose process to detect defective components of the NP Device v1, to avoid Real-time Self Diagnose device for brake system producing a false alarm condition.

5. Claim of claim 1; brake parts monitoring system is design in such a way if switch output in combination boxes, air chamber sensors, air line sensors, stop feeding continuous signals, to logic comparator; soon after brake pedal sensor signal to logic comparator becomes greater than zero; display console will receive a signal from logic comparator to indicate all systems are good.

6. Claim of claim 1; anti-false alarm system maintains a closed loop circuit comprises of power supply in logic comparator, electrically bridged with outer cover of combination box;
while outer cover is bridged with one end of the pulley return spring and other end of the spring is bridged with inner cable using a conductor; wherein inner cable is bridged with cable outer using a conductor inside brake shoe sensor and cable outer is connected to terminal on cable guide stand; and terminal on cable guide stand, is linked back to logic comparator.

7. Claim of claim 2; a pulley with an arm to convert slightest linear displacement in to a larger angular movement.

8. Claim of claim 2; wear & tear compensator comprises of movement regulator, which is a locking device, placed to prevent rotating platform movement, until switching arm apply force on rotating platform stoppers.

9. Claim of claim 2; wear & tear compensator comprises of Progressive direction stopper and retrieve direction stopper, placed & secured on each side of the rotating platform in a such a way, when switching arm attempt to exceeds its normal operating range on either direction, switching arm can exert force on either one of the stopper to move the rotating platform with the switch.

10. Claim of claim 2; Primary function of the brake shoe sensor is to measure total displacement of the brake shoes.

11. Claim of claim 2; displacement transfer cable has a third casing made of electrical insulation and dielectric material, placed between cable outer & inner cable, to form an electrical insulation barrier.

12. Claim of claim 2; displacement transfer cable has, an inner cable and cable outer, made of materials, capable of conducting electricity.

13. Claim of claim 2; switch output will not emit continuous signal as far as switching arm hold switch in off position.

14. Claim of claim 2; arm attached to pulley, named as switching arm, is constructed in a such a way, the length from switching arm lip to the center of the hole for vertical axle, is much greater than the length from pulley groove bottom, to the center of the hole for vertical axle.

15. Claim of claim 5; brake parts monitoring system is design in such a way if any one or more or combination of air line sensors, air chamber sensors, feed continuous signals to logic comparator; even after brake pedal sensor signal to logic comparator, becomes greater than zero; brake parts monitoring system will flag logic comparator; to signal display console to indicate, one or more pneumatic components of respective wheel is defective.

16. Claim of claim 14; switching arm is constructed in a such a way, switching arm length varies from 1″ to 4″, while radius of the pulley at pulley groove bottom, varies from 0.150″ to 0.450″, depending on the vehicle NP Device is installed.
